(19) United States
(12) Patent Application Publication
(10) Pub. No.: US 2020/0333252 A1
(43) Pub. Date: Oct. 22, 2020

(54) DEVICE AND METHOD FOR SUPER-RESOLUTION FLUORESCENCE MICROSCOPY AND FLUORESCENCE LIFETIME MEASUREMENT

(71) Applicants: CENTRE NATIONAL DE LA RECHERCHE SCIENTIFIQUE, PARIS (FR); ECOLE SUPERIEURE DE PHYSIQUE ET DE CHIMIE INDUSTRIELLES DE LA VILLE DE PARIS, PARIS (FR)

(72) Inventors: Valentina KRACHMALNICOFF, PARIS (FR); Ignacio IZEDDIN, PARIS (FR); Dorian BOUCHET, PARIS (FR); Yannick DE WILDE, PARIS (FR)

(21) Appl. No.: 16/758,002

(22) PCT Filed: Oct. 31, 2018
(86) PCT No.: PCT/EP2018/079865

§ 371 Date: Apr. 21, 2020

(30) Foreign Application Priority Data
Nov. 2, 2017 (FR) 1760334

(51) Int. Cl. G01N 21/64; G02B 21/00; G02B 27/58

(52) U.S. Cl. CPC G01N 21/6458; G01N 21/6408; G01N 21/6428; G02B 27/58; G02B 21/0072; G02B 21/008; G02B 21/0076

(57) ABSTRACT

A method for super-resolution fluorescence microscopy includes the following steps: provoking the stochastic activation of fluorescent emitters contained in a sample to be observed, and illuminating the sample with an excitation light beam having a wavelength suitable for inducing fluorescent emission from the activated emitters; and acquiring a sequence of fluorescence images by means of an imaging system comprising a matrix image sensor; measuring arrival delays of fluorescence photons relative to the pulses of the excitation light beam, with a spatial resolution allowing each photon to be associated with a set of pixels of the matrix image sensor. A device and computer program product for the implementation of such a method are also provided.

The invention relates to a device and to a method of super-resolution fluorescence microscopy that makes it possible to perform fluorescence lifetime measurements with a nanometric spatial resolution and on the scale of the individual molecule. It relates also to a computer program product that makes it possible to implement the data processing steps of such a method.

The invention falls within the field of optical microscopy, and more specifically of fluorescence microscopy, and is primarily intended for applications to biology and to biochemistry.

The spatial resolution of the conventional optical microscopy techniques is limited by the diffraction effects to a value of the order of magnitude of the wavelength of the light used (typically a few hundreds of nanometers). Numerous methods have however been considered to allow better resolutions than the diffraction limit to be obtained; these are then qualified as “super-resolution”. Techniques that can in particular be cited include near-field imaging and far-field fluorescence microscopy techniques such as structured illumination microscopy. The fluorescence microscopy techniques are particularly important in biology, and their development has notably been rewarded by the 2014 Nobel prize in chemistry.

Super-resolution fluorescence microscopy techniques that can be cited include in particular STED (“STimulated-Emission-Depletion”) microscopy and SMLM (“Single-Molecule Localization Microscopy”), which includes PALM (“Photoactivated Localization Microscopy”), and STORM (Stochastic Optical Reconstruction Microscopy”). See for example:
S. W. Hell, J. Wichmann “Breaking the diffraction resolution limit by stimulated emission: stimulated-emission-depletion fluorescence microscopy”, Optics Letters, Vol. 19, No. 11, Jun. 1, 1994;
T. A. Klar et al. “Fluorescence microscopy with diffraction resolution barrier broken by stimulated emission”, PNAS, Vol. 97, No. 15, Jul. 18, 2000.

STED microscopy is a scanning confocal microscopy technique that uses two colinear illuminating light beams: a first beam exciting the fluorescent emission of a fluorophore (fluorescent marker) and a second beam, in ring form, which induces a depletion of the stimulated emission switching off the fluorescence in the periphery of the region illuminated by the first beam. This technique makes it possible to obtain a resolution of a few tens of nanometers but, as in all the scanning techniques, the acquisition time depends on the size of the image and can become very significant. Furthermore, it allows the detection of the individual molecules only when the density of the fluorescent marking is very low, such that, on average, a single fluorescent molecule is located in a diffraction spot. Even in this case, it is impossible to track the diffusion of a molecule.

SMLM is a technique of stochastic type, which uses photoconvertible fluorescent markers, that is to say markers that can switch from a first state to a second state under the effect of a light radiation at a determined wavelength. The illumination is done by means of two light beams of different wavelengths: a first beam which induces the photoconversion of the marker, and a second beam which induces a fluorescent emission of the molecules of the marker that are in their second state (photoconverted or photoactivated). The molecules of the marker switch randomly from the first state to the second state. In the second state, the molecules can be excited by the second beam and emit fluorescence photons for a limited time until they undergo an irreversible alteration (bleaching) which switches off their fluorescence, this time being typically of the order of a few tens of milliseconds. Thus, the fluorescence of the different molecules of the marker “switches on” and “switches off” over time randomly. Several successive images are acquired, in which the different individual fluorescent emitters appear as diffraction spots. The intensity of the first beam is chosen such that, at a given instant, the molecules in the second state and therefore that are emitting a fluorescence radiation when they are excited by the second beam, are spaced apart by an average distance greater than the diffraction limit. In this way, most of the diffraction spots can be distinguished, which allows for the identification of the individual fluorescent emitters. Then, the position of the latter is determined with nanometric precision by estimating the center of the corresponding diffraction spot. In this way, a super-resolved image can be reconstructed. Compared to STED microscopy, the SMLM technique has the advantage of being “full field”, therefore with an acquisition time that is independent of the size of the image, and of allowing the identification and the tracking in time of individual molecules. SMLM is described, for example, in:
E. Betzig et al. “Imaging Intracellular Fluorescent Proteins at Nanometer Resolution”, Science, Vol. 313, Sep. 15, 2006;
M. J. Rust et al. “Sub-diffraction-limit imaging by stochastic optical reconstruction microscopy (STORM)”, Nature Methods, Vol. 3, No. 10, October 2006.

The lifetime of the fluorescence of a fluorophore (that is to say the reciprocal of the rate of decay of its probability of de-excitation) depends on its environment and on the molecular interactions that it undergoes. Its measurement therefore provides useful information on the biochemical context. Fluorescence lifetime imaging microscopy (FLIM) is an imaging technique that produces images based on the fluorescence lifetime differences of a fluorescent sample. Typically, its resolution is limited by diffraction. See for example:
C.-W. Chang et al. “Fluorescence Lifetime Imaging Microscopy”, Methods in Cell Biology, Vol. 81, chapter 24.

Two techniques have been proposed in order to obtain fluorescence lifetime measurements with a spatial super-resolution. The document EP 1 584 918 describes a method combining the STED and FLIM techniques, and a device for the implementation thereof. This approach has the drawbacks already described with respect to STED microscopy: acquisition time dependent on the size of the image because of the fact that the excitation of the fluorescent molecules is performed by confocal scanning, and therefore potentially very lengthy scanning, and impossibility of detecting individual molecules. Furthermore, the light intensities implemented are high, and therefore difficult to reconcile with in vivo imaging because of the well-known phenomena of phototoxicity.

The document CN 102033058 describes a microscopy device comprising two objectives arranged face-to-face. One of these objectives is used to detect, by scanning, individual molecules, while the other makes it possible to perform fluorescence lifetime measurements. While it does allow the detection of individual molecules, this technique has the drawback common to all the scanning approaches, namely an acquisition time dependent on the size of the image. Furthermore, the device is not based on a conventional (market-standard) microscope and its alignment is very complex and difficult.

The document US 2013/0126755 reports on a device that makes it possible to acquire, synchronously, several fluorescence microscopy parameters. More particularly, such a device comprises a TSCSPC (time- and space-correlated single photon counting) detector associated with a peripheral device. The TSCSPC technique is described in more detail in the article by Sergei Stepanov, Sergei Bakhlanov, Evgeny Drobchenko, Hann-Jorg Eckert, Klaus Kemnitz “Widefield TSCSPC-Systems with Large-Area-Detectors: Application in simultaneous Multi-Channel-FLIM” Proceedings of SPIE, June 2010.

The document US 2013/0015331 and the article by I. Michel Antolovic “Photon-Counting Arrays for Time-Resolved Imaging” disclose matrices of single photon detectors associated with arrays of microlenses, and their application to fluorescence microscopy techniques.

The document EP 3 203 215 discloses a spectral imaging device comprising a matrix of light detectors associated with a bundle of optical fibers.

The invention aims to overcome the abovementioned drawbacks of the prior art. More specifically, it aims to provide a “full-field” super-resolution microscopy technique, that allows for the detection and tracking in time of individual molecules and a simultaneous measurement of their fluorescence lifetimes. Advantageously, such a technique should be simple to implement around a market-standard microscopy system and compatible with the imaging of living cells.

According to the invention, this aim is achieved by combining the SMLM technique and fluorescence lifetime measurements. It is interesting to note that this combination was previously deemed impossible: see Becker, W. (Ed.) (2015). “Advanced time-correlated single photon counting applications (Vol. 111)” Springer (Chapter 2, Wolfgang Becker, Vladislav Shcheslayskiy, Hauke Studier “TCSPC FLIM with Different Optical Scanning Techniques”, section 2.10).

A subject of the invention is therefore a super-resolution fluorescence microscopy method comprising the following steps:
a) provoking a stochastic activation of fluorescent emitters contained in a sample to be observed, and illuminating said sample with an excitation light beam having a wavelength suitable for inducing a fluorescent emission from the activated emitters; and
b) acquiring a sequence of images of said fluorescent emission by means of an imaging system comprising a matrix image sensor; characterized in that:
   said excitation light beam is pulsed, the time interval between two successive pulses being greater than the fluorescence lifetime of the fluorescent emitters;
   in that it also comprises a step of counting of photons of the fluorescent emission to determine arrival delays of said photons relative to the pulses of said excitation light beam, said counting being performed with a spatial resolution allowing each photon to be associated with a set of pixels of said matrix image sensor; and
   in that the stochastic activation of the fluorescent emitters is performed in such a way that, during the time of acquisition of one said image, at most one individual fluorescent emitter is activated on average in a region of the sample corresponding to one said set of pixels of the matrix image sensor.

More particularly, according to a first embodiment, the method comprises the following steps:
a) illuminating a sample containing photoconvertible fluorescent emitters by means of a first light beam at a first wavelength and a second light beam at a second wavelength, the first wavelength being chosen so as to activate said fluorescent emitters by provoking their conversion from a first state to a second state that is different from the first, the second wavelength being different from the first and suitable for inducing a fluorescent emission of the fluorescent emitters in their second state; and
b) acquiring a sequence of images of said fluorescent emission by means of an imaging system comprising a matrix image sensor;
   and is characterized in that:
   said second light beam is pulsed, the time interval between two successive pulses being greater than the fluorescence lifetime of the fluorescent emitters;
   and in that it also comprises a step of counting of photons of the fluorescent emission to determine arrival delays of said photons relative to the pulses of said second light beam, said counting being performed with a spatial resolution allowing each photon to be associated with a set of pixels of said matrix image sensor; and
   in that the intensity of the first light beam is chosen such that, during the time of acquisition of one said image, at most one individual fluorescent emitter is activated on average in a region of the sample corresponding to one said set of pixels of the matrix image sensor.

According to a second embodiment of the method: the sample:
has a sub-micrometric thickness,
is deposited on a face of a dielectric support that is transparent to the wavelength of the excitation light beam,
has a surface opposite the support which is functionalized with molecules of a first type and is placed in contact with a solution containing molecules of a second type bonded to fluorescent emitters and susceptible to bonding transiently with the molecules of the first type by a reaction having a kinetic such that, on average, at most one molecule of the second type is bonded to a molecule of the first type in a region of the sample corresponding to one said set of pixels of the matrix image sensor; and:
the step a) comprising the illumination of the sample by total internal reflection by means of said excitation light beam such that the fluorescent emission from the sole fluorescent emitters situated at a sub-micrometric distance from the face of the dielectric support is activated.

According to advantageous features of such a method, taken individually or in combination:
said photon counting step can comprise:
c) directing a portion of said fluorescent emission to a photon-counting detector or matrix of detectors, said or each detector of the matrix being associated with a set of pixels of said matrix image sensor; and
d) using the photon-counting detector or detectors to measure arrival delays of fluorescence photons relative to the pulses of said excitation light beam (second light beam).

The method can also comprise the following steps:
e) using the sequence of images acquired in the step b) to construct a super-resolution image by locating said individual fluorescent emitters;
f) using the arrival delays of the fluorescence photons measured in the step d) to calculate fluorescence lifetimes, and associate them with the individual fluorescent emitters located in the step e); the steps e) and f) being implemented by means of an electronic processor.

Said step e) can comprise a location of said individual fluorescent emitters by estimating the centers of diffraction spots present in the images acquired in the step b).

The method can also comprise a step g) of space-time correlation between the images acquired in the step b) and the arrival delays of the fluorescence photons measured in the step d) to associate said fluorescence lifetimes with said individual fluorescent emitters.

Said matrix of photon-counting detectors can comprise a plurality of said detectors arranged according to a plurality of rows and of columns.

Another subject of the invention is a super-resolution fluorescence microscopy device comprising:
a means for stochastic activation of fluorescent emitters contained in a sample to be observed;
a light source, called excitation light source, suitable for emitting a light beam, called excitation light beam, at a wavelength suitable for inducing a fluorescent emission from the activated fluorescent emitters;
an optical system configured to direct the excitation light beam toward the sample;
an optical detection system comprising a matrix image sensor configured to acquire a sequence of fluorescence images of said sample;
   characterized in that:
said excitation light source is a pulsed source, the time interval between two successive pulses of this source being greater than the fluorescence lifetime of the fluorescent emitters; and in that the optical detection system is also configured to perform a counting of photons of the fluorescent emission to determine arrival delays of said photons relative to the pulses of said second light beam, said counting being performed with a spatial resolution allowing each photon to be associated with a set of pixels of said matrix image sensor.

According to a first embodiment, the device comprises:
a first light source suitable for emitting a first light beam at a first wavelength, said first wavelength being chosen so as to activate fluorescent emitters by provoking their conversion from a first state to a second state that is different from the first;
a second light source suitable for emitting a second light beam at a second wavelength, different from the first, said second wavelength being different from the first and suitable for inducing a fluorescent emission of the fluorescent emitters in their second state;
an optical system configured to direct the first light beam and the second light beam toward a sample;
an optical detection system configured to acquire a sequence of fluorescence images of said sample;
   and is characterized in that:
said second light source is a pulsed source, the time interval between two successive pulses of this source being greater than the fluorescence lifetime of the fluorescent emitters; and in that the optical detection system is also configured to perform a counting of photons of the fluorescent emission to determine arrival delays of said photons relative to the pulses of said second light beam, said counting being performed with a spatial resolution allowing each photon to be associated with a set of pixels of said matrix image sensor.

According to a second embodiment of the device, the means for stochastic activation of fluorescent emitters comprises a dielectric support that is transparent to the wavelength of the excitation light beam, on a face of which the sample can be deposited, and a fluid tank containing said support; said optical system being configured to direct the excitation light beam through the support such that it undergoes a total internal reflection on said face.

According to advantageous features of such a device, taken individually or in combination:
the optical detection system can comprise: an imaging system configured to acquire said sequence of fluorescence images of said sample; a photon-counting detector or matrix of detectors arranged so as to receive a portion of a fluorescent emission from said sample, said or each detector of the matrix being associated with said set of pixels of said matrix image sensor; and an electronic circuit associated with said photon-counting detector or matrix of detectors, configured to measure arrival delays of photons arriving on said or each said detector relative to the pulses of said second light beam.

The device can also comprise an electronic processor configured to: receive as input the sequence of fluorescence images acquired by said matrix image sensor and use it to construct a super-resolution image by locating, in the images of the sequence, individual fluorescent emitters; receive as input delay measurements obtained by said electronic circuit and use them to calculate fluorescence lifetimes; and associate said fluorescence lifetimes with the located individual fluorescent emitters.

Said electronic processor can be configured to locate said individual fluorescent emitters by estimating the centers of diffraction spots present in the images acquired by said matrix image sensor.

Said electronic processor can be configured to associate said fluorescence lifetimes with the located individual fluorescent emitters by performing a space-time correlation between the images acquired by said matrix image sensor and the delay measurements obtained by said electronic circuit.

Said photon-counting detector or detectors can be individual photon avalanche diodes.

The device can comprise one said matrix of photon-counting detectors. The matrix of photon-counting detectors can notably be a matrix of non-contiguous individual photon avalanche diodes, the device also comprising a matrix of contiguous convergent microlenses comprising one said microlens arranged facing each individual photon avalanche diode of the matrix, each said microlens being optically conjugate with a set of pixels of said matrix image sensor.

Alternatively, the device can comprise a plurality of said photon-counting detectors, and a bundle of optical fibers such that a first end face of each optical fiber is optically conjugate with a set of pixels of said matrix image sensor, one said photon-counting detector being arranged facing a second end face of each said optical fiber.

Yet another subject of the invention is a computer program product comprising computer-executable instructions for implementing at least the steps e) and f) of a method as described above.

Other features, details and advantages of the invention will emerge on reading the description given with reference to the attached figures given by way of example and which represent, respectively:

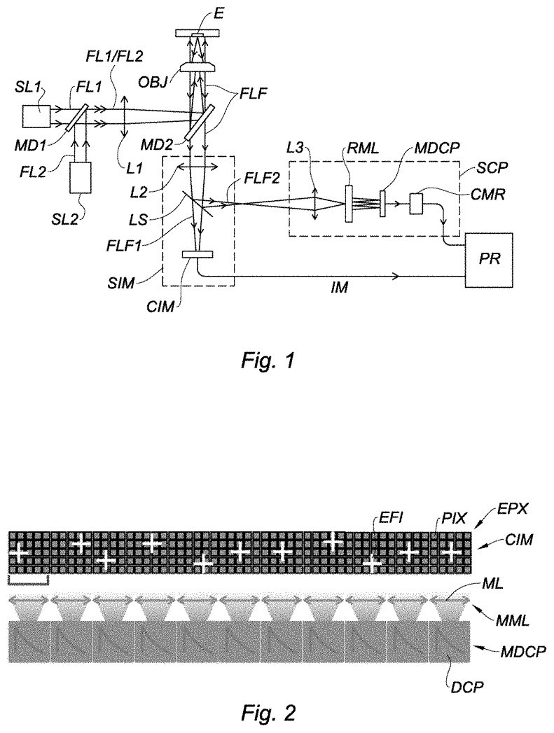

FIG. 1, a diagram of a device according to an embodiment of the invention;

FIG. 2, a functional representation of a matrix of photon-counting detectors associated with an array of microlenses in the device of FIG. 1;

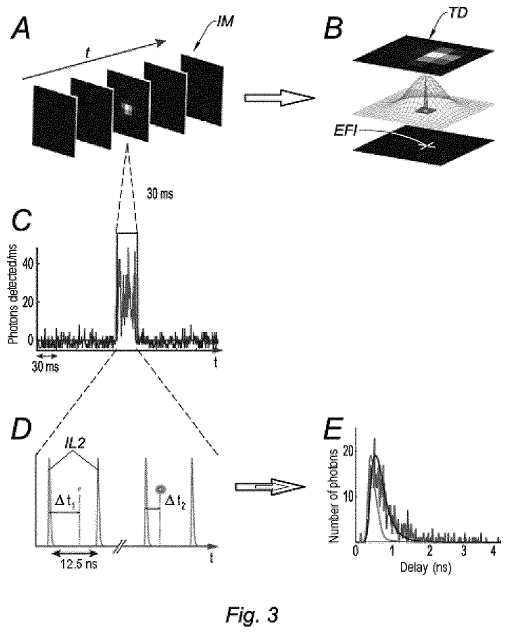

FIG. 3, an illustration of the principle of the invention;

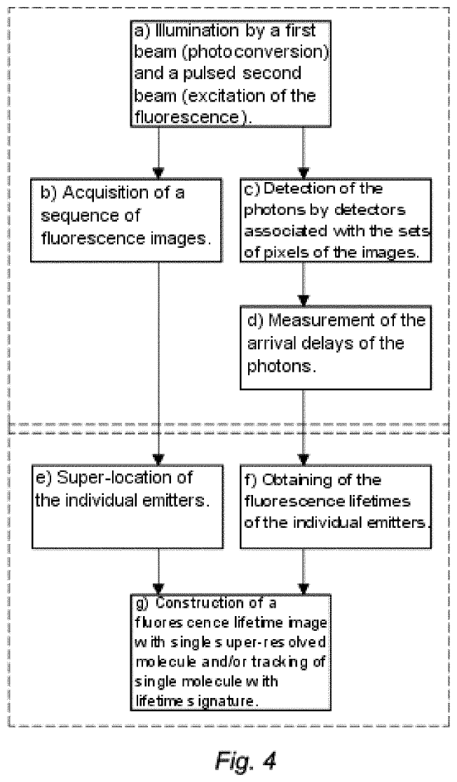

FIG. 4, a flow diagram of a method according to the invention;

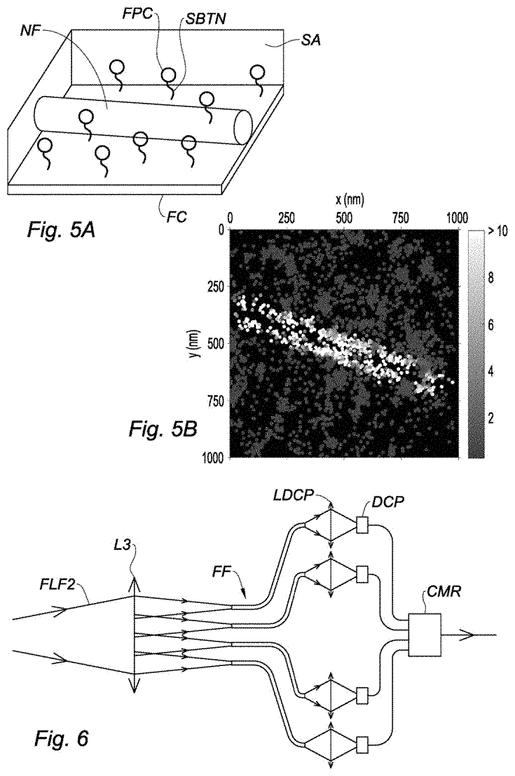

FIGS. 5A and 5B, a proof of principle of the invention, obtained by using a single-pixel sensor;

FIG. 6, a detail of a device according to an alternative embodiment of the invention;

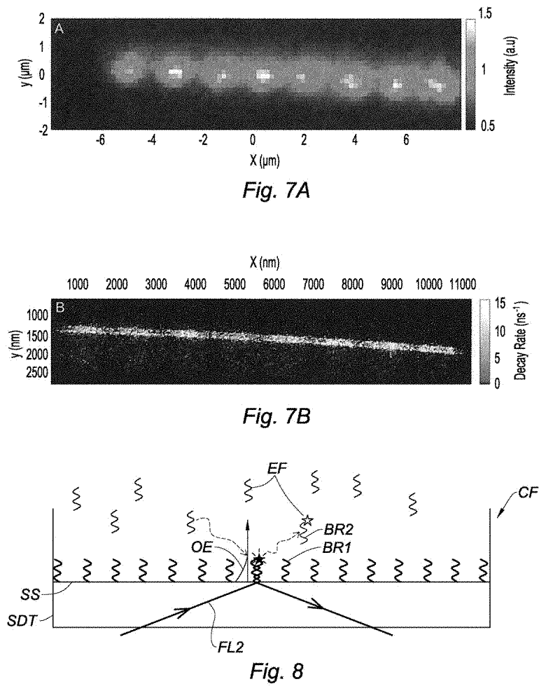

FIGS. 7A and 7B, images obtained by means of the device of FIG. 1; and

FIG. 8, a detail of a device according to another alternative embodiment of the invention.

As illustrated in FIG. 1, a device according to an embodiment of the invention comprises two optical sources, generally lasers:

A first source SL1 (conversion source) emits a first light beam FL1 (conversion beam) at a wavelength λ₁ capable of inducing the photoactivation of a photoconvertible fluorescent marker. For example, when the marker is a Dendra, EOS or Alexa Fluor (registered trademarks) photoactivable fluorophore, it can be a low-power laser diode (<1 mW) emitting at a wavelength of 405 nm.

A second source SL2 (excitation source) emits a second light beam FL2 (excitation beam) at a wavelength λ₂ capable of exciting the fluorescent marker photoactivated by the first beam. This second source is of pulsed type, generally picoseconds (pulse duration lying between 100 fs and 100 ps) or femtoseconds (pulse duration less than 100 fs), with a spacing between pulses greater than the fluorescence lifetime of the photoactivated marker, which is generally of the order of a few nanoseconds. As will be explained later, the pulsed nature of the second source is necessary to allow the fluorescence lifetime measurements. It can be, for example, for Alexa Fluor 674, a pulsed laser diode emitting at a wavelength of 647 nm with a power of the order of the mW, with a repetition rate of 80 MHz and pulse duration of the order of 100 ps.

The beams FL1 and FL2 are combined using a first dichroic mirror MD1, focused by a convergent lens L1 then directed by a second dichroic mirror MD2 so that the beams are focused on the rear focal plane of an objective OBJ with wide numerical aperture, for example the objective of a commercial microscope. The beams, after the objective, are therefore collimated and the sample E is illuminated in full field. The sample E can contain biological or biochemical species or nano-objects marked by photoconvertible fluorophores sensitive to the wavelengths λ₁ and λ₂, for example fluorescent proteins like Dendra or Eos (activation at 405 nm, excitation of the activated state at 561 nm) or organic colorants like Alexa Fluor 647 (activation at 405 nm, excitation at 647 nm). Dendra, Eos and Alexa Fluor 647 are trade names and registered trademarks.

The fluorescence radiation emitted by the sample E is collected by the objective OBJ to form a parallel beam FLF which passes through the second dichroic mirror MD2, is focused by a second convergent lens L2 and is split by a splitter plate LS into two components FLF1 and FLF2.

The component FLF1 is directed to a matrix image sensor CIM, for example of the EM-CCD type (electron-multiplying charge-coupled device) or sCMOS type (scientific CMOS), optically conjugate with the sample E so as to acquire fluorescence images IM thereof. The lens L2 and the sensor CIM thus form an imaging system SI.

The rate of acquisition of the images by the matrix sensor CIM is very much lower (by a factor of 10⁵-10⁷) than the repetition frequency of the pulses of the second light source SL2, and typically of the order of 10-100 ms per frame. The part A of FIG. 3 schematically represents a sequence of images acquired over the time t, one of these images showing a light spot corresponding to an activated fluorescent emitter.

The photoactivation of the fluorophores of the sample by the first light beam is a stochastic phenomenon, and the probability of a given fluorophore being activated during the time of acquisition of a frame of the sensor CIM depends on the intensity of the beam FL1. According to the invention, this intensity is chosen such that the activated fluorophores—and therefore fluorescent fluorophores—can be resolved on the images. The maximum admissible intensity of the beam FL1 depends on the density of the fluorophores, on their photoactivation dynamic, on the thickness of the sample, on the characteristics of the imaging optical system and on the rate of acquisition of the images.

An electronic processor PR—which can be, for example, a computer, a computer network, a dedicated electronic circuit, etc.—receives as input the images IM acquired by the sensor CIM and processes them in accordance with the SMLM principle, by fitting a Gaussian distribution to each visible light spot on an image and by considering that an individual fluorescent emitter (reference EFI in FIGS. 2 and 3) correlates with the center of the distribution. The mean square error of the location—inversely proportional to the square root of the number of photons acquired—is typically of the order of 10 nm, an order of magnitude less than the diffraction limit. That is illustrated in parts A and B of FIG. 3.

The component FLF2 of the fluorescence radiation is directed toward a photon counting system SCP comprising—in the embodiment of FIG. 1—a lens L3, a matrix of convergent microlenses MML and a matrix of photon-counting detectors MDCP. The detectors are advantageously single-photon avalanche diodes (SPAD, which stands for “Single-Photon Avalanche Detector”).

The matrix of microlenses is optically conjugate with the sample—in other words, an image of the sample is formed on its surface. As illustrated in FIG. 2, each photon-counting detector DCP is arranged behind a respective microlens, ML. The microlens ML concentrates on the detector ML the photons originating from a region of the sample which is conjugate with a set EPX of a plurality of pixels PIX of the sensor CIM (25 pixels forming a 5×5 square in the example of FIG. 2). The main function of the matrix of microlenses is to enhance the fill factor of the matrix of detectors. In fact, because of the constraints inherent to the SPAD technology, a matrix MDCP typically has detectors of 50 pm side and a pitch of 250 μm. Without microlenses, consequently, a large majority of the photons arriving at the matrix of detectors would be lost. It will also be understood that FIG. 2, in which the “inactive” parts of the matrix of photodetectors are not represented, constitutes only a functional illustration, and not a faithful representation of the assembly of matrix of microlenses and matrix of detectors.

The dimensions of the set EPX associated with a photon-counting detector are chosen as a function of the light intensity of the beam FL1 such that the probability of having two fluorescent emitters activated “at the same time” (that is to say during a same image acquisition time) in a region corresponding to a set EPX is negligible (for example, not greater than 1/100). At the very least, it will be demanded that the average number of fluorophores activated during a same image acquisition time in a region corresponding to a set EPX does not exceed 1. The maximum admissible intensity of the beam FL1 depends on the density of the fluorophores, on their photoactivation dynamic, on the thickness of the sample, on the size of the set EPX and on the rate of acquisition of the images.

FIG. 2 shows a single individual fluorescent emitter EFI in each set of pixels EPX associated with a respective detector DCP of the matrix MDCP. In these conditions, all the photons detected by the detector DCP can be attributed to the emitter EFI, that is to say to an individual molecule whose position, as was explained above, can be determined with nanometric precision. The part C of FIG. 3 is a graph representing the number of photon counts per millisecond by a detector DCP during the time of acquisition of a fluorescence image.

An electronic circuit CMR makes it possible to measure the delay (Δt₁, Δt₂ in the part D of FIG. 3) of each photon detected relative to the immediately preceding pulse IL2 of the fluorescence excitation light beam FL2. The circuit should have a time resolution that is better by at least a factor of 10, and preferably by at least a factor of 100, than the fluorescence lifetime to be determined. Typically, this time resolution should be of the order of a picosecond (better, 100 ps, preferably better, 10 ps).

From these measurements, the processor PR constructs a histogram of the delays (part E of FIG. 3), and uses that to calculate the fluorescence lifetime of the individual emitter EFI. It will be noted that the circuit CMR receives a signal representative of the instant of emission of each pulse IL2, the signal originating for example from a photodiode. That is not represented so as not to clutter up the figure.

Thus, the invention makes it possible to measure the lifetime of individual fluorescent molecules whose position is determined with a spatial resolution far better than the diffraction limit, even in dense marking conditions (for example 1 molecule every 10 nm).

FIG. 4 schematically illustrates the different steps of a method according to the invention.

The step a) corresponds to the illumination of the sample E by the photoactivation beam FL1 and the pulsed fluorescence excitation beam FL2. Simultaneously, a sequence of fluorescence images is acquired (step b) and the detection of photons (step c), with the measurement of their time of arrival (step d), by detectors associated with the pixels of the images, is performed.

The following steps are implemented by the electronic processor PR, generally by means of appropriate software: the individual emitters are super-located based on the images acquired in the step b (e) and the fluorescence lifetimes of these emitters are obtained from the photon arrival delays (f). A space-time correlation of the data generated in the steps e) and f) makes it possible to construct a super-resolved single molecule fluorescence lifetime image, and/or to track the diffusion of a single molecule with its fluorescence lifetime signature, and even the trend of said lifetime (step g).

More specifically, in order to limit the artefacts, the dataprocessing software run by the processor PR preferably performs the following operations:

Thresholding of the signals acquired by the matrix image sensor and by the photon-counting detectors, so as to retain only the signals which effectively correspond to the detection of a photoactivated fluorescent molecule and to reject the noise.

Filtering of the signals exhibiting abnormal temporal characteristics. For example, the photobleaching switches off the fluorescence in a time whose average value is known (for example, 30 ms). If the images acquired by the sensor CIM show a light spot which persists for too long, that means that it is due to several molecules, and should therefore be discarded. Regarding the photon-counting detectors, it is expected that a signal will be seen which “blinks” above and below a threshold several times in the space of a few milliseconds, and that at least a predefined minimum number of photons (typically a few hundred, for example 250) will be detected. If these conditions are not fulfilled, the signals are discarded.

Binary representation of the data deriving from the two detectors (image sensor and matrix of photon-counting detectors), in the form of “events”. Only the signals corresponding to spatially and temporally correlated events are used for the reconstruction of the step g). At the end of this step, the position of each individual fluorescent emitter is associated with its fluorescence lifetime.

If several fluorescent emitters are detected at the same time in one and the same set of pixels of the image sensor, various rules can be applied. One possibility consists in purely and simply discarding the corresponding signals. Another possibility consists in disregarding emitters situated close to the edge of the set of pixels. A third possibility relies on the fact that the response of the DCP is not the same for an emitter which is at the center of the EPX and at its edge. Consequently, knowledge of the fraction of the number of photons detected by the DCP for each emitter makes it possible to assign a confidence score to the lifetime measurement. For example, this score will be high in the case of the simultaneous detection of one emitter at the center of the EPX and a second at the edge, whereas it will be low for the simultaneous detection of two emitters at the same distance from the center. The first detection will be retained, while the second will be rejected.

The invention has been described with reference to a particular embodiment, but variants are possible.

For example, it is possible, at least in principle, to use one and the same detector, such as a microchannel plate (MCP) to perform the counting of photons and the acquisition of images at the same time. The simplification of the optical system that is thus obtained, however, does not generally justify the performance degradation that that causes.

A second possibility consists in imaging the zone of interest of the sample on the input of a bundle of optical fibers FF by means of the lens L3 in the SCP part of the device; thus, an input face of each fiber is optically conjugate with a set of pixels of the sensor CIM. At the output of each fiber, the signal is detected on a detector DCP via a respective lens LDCP. This configuration makes it possible to dispense with the use of the array of microlenses and of the array of detectors in favor of the use of LDCP lenses and individual detectors. This variant is illustrated in FIG. 6.

The matrix of microlenses and the matrix of photon-counting detectors are preferably two-dimensional and arranged in rows and in columns, but that is not essential. It is also possible to use one-dimensional matrices and/or matrices having a non-cartesian organization.

Another variant consists in using a single photon-counting detector, instead of a matrix. That makes it possible to avoid the use of a matrix of microlenses. The corollary is that the field of view of the imaging system must be very limited, corresponding to a single set of pixels of FIG. 2, which in turn must be fairly small to contain, on average, only a single photoactivated molecule at the same time (that is to say over an acquisition time of the sensor CIM). This simplified embodiment was used to produce a proof of principle of the invention. As illustrated in FIG. 5A, a silver nanowire NF (diameter 100 nm, length of a few micrometers) was immersed in an aqueous solution SA contained in a dish. A photoconvertible fluorophore Alexa Fluor 647 is bonded by covalence with a protein, streptavidine, which is bonded to the surface of the nanowire and of the glass plate by means of biotine. Streptavidine has a bond affinity to biotine that is very high, and a conjugate of streptavidine is commonly used at the same time as a conjugate of biotine for the specific detection of a variety of proteins. In FIG. 5A, the reference FPC denotes the photoconvertible fluorophore (Alexa Fluor 647) and the reference SBTN denotes the streptavidine-biotine complex. FIG. 5B is the image obtained by a device similar to that of FIG. 1, but comprising a single photon-counting detector. The visual field is 1000×1000 nm (1 μm²). The gray shades correspond to the inverse of the fluorescence lifetimes (rates of deexcitation) measured. It can be seen that the molecules of Alexa Fluor 647 which adhere to the bottom FCV of the dish exhibit a fluorescence deexcitation rate of the order of 1 ns⁻¹. This rate increases by more than an order of magnitude for the molecules bonded to the nanowire. Since the illumination is through the bottom of the dish, the top part of the nanowire is in shade and appears black.

FIGS. 7A and 7B show images obtained by means of the device of FIG. 1 with a matrix of convergent microlenses and a matrix of eight photon-counting detectors. More specifically, FIG. 7A illustrates the spatial correlation of the matrix of photon-counting detectors and the matrix image sensor in the plane of the sample. More specifically, this figure illustrates how, using the array of microlenses, zones that are contiguous in the plane of the sample are optically conjugate with each of the photon-counting detectors, with no loss of information between each of said zones. FIG. 7A was obtained by scanning a spotlight source (a fluorescent ball) in the plane of the sample and by representing the fluorescence intensity measured by each of the photon-counting detectors for each position of the ball (pixels of the image). FIG. 7B is a mapping of the changing fluorescence lifetime induced by the presence of a silver nanowire (diameter 100 nm) as described for FIG. 5.

The invention has been described with reference to particular embodiments, using photoconvertible fluorescent emitters. That is not however essential. Indeed, what counts for the implementation of the invention is that the fluorescent emitters be activated stochastically such that, on average, a single emitter at most is activated in a region of the sample corresponding to a set of pixels of the matrix image sensor. That can be obtained other than by photochemical means. It is for example possible to use the uPAINT and DNA-PAINT techniques described respectively in the following articles:
Gregory Giannone et al. “Dynamic-Superresolution Imaging of Endogenous Proteins on Living Cells of Ultra-High Density”, Biophysical Journal, Vol. 99, August 2010, pages 1303-1310;
Joerg Schnitzbzauer et al. “Super-resolution microscopy with DNA-PAINT”, Nature Protocols, Vol. 12, No. 6, pages 1198-1228 (2017).

These approaches use a sample functionalized by molecules of a first type, placed in contact with a solution of molecules of a second type which are in turn marked by fluorescent emitters (in the case of DNA-PAINT, the molecules of the first type and of the second type are DNA strands). The molecules of the first type and of the second type are susceptible to bonding with one another transiently. A suitable lighting system is used to activate the fluorescence of only the emitters which are located at less than a micrometer, even a few hundreds of nanometers, from the surface of the sample—therefore, in practice, the emitters bonded to the molecules of the second type which are at a given moment to be bonded to the sample via molecules of the first type. That can be obtained, for example, by means of a highly inclined lighting (angle of incidence of the order of 85° or more) or in total internal reflection.

FIG. 8 relates to the latter case. The sample E takes the form of a thin layer deposited on the surface SS of a transparent dielectric support SDT, for example a glass plate. The excitation light beam FL2 passes through the support and undergoes a total internal reflection on its surface SS, which generates an evanescent wave OE that develops over a distance of approximately 200 nm.

The surface of the sample is covered with a DNA strand (BR1) with high density (a density equal to or greater than one strand per 10 nm). The support—sample assembly is in a fluid tank CF filled with a solution in which there are second DNA strands (BR2) to which there are attached conventional fluorophores (not photoactivatable) EF. In solution, outside of the zone illuminated by the evanescent wave, the fluorophore is not excited. The DNA strands BE1 and BR2 have a recognition sequence with a weak interaction, the bonding kinetic of which can be controlled through the length of the DNA strands. By diffusion, BR2-fluorophore complexes arrive in proximity and attach to the strands BR1 transiently, which allows for the excitation of the corresponding fluorophores. The latter then emit photons and are detected as individual fluorophores by the matrix image detector and the photon-counting detector. After photobleaching, and according to the BR1-BR2 bonding kinetic, each BR2-fluorophore complex detaches from the strand BR1 and, by diffusion, leaves the zone of illumination by evanescent wave. The phenomenon is repeated until a dense mapping as described above is obtained. To ensure that, on average, at most a single emitter is activated in a region of the sample corresponding to a set of pixels of the matrix image sensor, and therefore allow for the detection of individual fluorophores, it is possible to act on two parameters: the bonding kinetic (which depends on the length of the DNA strands) and the density of the strands BR2 in solution.

1. A super-resolution fluorescence microscopy method comprising the following steps:
a) provoking a stochastic activation of fluorescent emitters contained in a sample (E) to be observed, and illuminating said sample with an excitation light beam (FL2) having a wavelength suitable for inducing a fluorescent emission (FLF) from the activated emitters; and
b) acquiring a sequence of images (IM) of said fluorescent emission by means of an imaging system (SIM) comprising a matrix image sensor (CIM); wherein:
said excitation light beam is pulsed, the time interval between two successive pulses being greater than the fluorescence lifetime of the fluorescent emitters;
in that it also comprises a step of counting of photons of the fluorescent emission to determine arrival delays of said photons relative to the pulses (IL2) of said excitation light beam, said counting being performed with a spatial resolution allowing each photon to be associated with a set of pixels (EPX) of said matrix image sensor; and
in that the stochastic activation of the fluorescent emitters is performed in such a way that, during the time of acquisition of one said image, at most one individual fluorescent emitter (EFI) is activated on average in a region of the sample corresponding to one said set of pixels of the matrix image sensor.

2. The method as claimed in claim 1, wherein said photon counting step comprises:
c) directing a portion of said fluorescent emission to a photon-counting detector or matrix of detectors (MDCP, said or each detector of the matrix (DCP) being associated with a set of pixels (EPX) of said matrix image sensor; and
d) using the photon-counting detector or detectors to measure arrival delays (Δt₁, Δt₂) of fluorescence photons relative to the pulses of said excitation light beam.

3. The method as claimed in claim 2, also comprising the following steps:
e) using the sequence of images acquired in the step b) to construct a super-resolution image by locating said individual fluorescent emitters;
f) using the arrival delays of the fluorescence photons measured in step d) to calculate fluorescence lifetimes, and associate them with the individual fluorescent emitters located in the step e);
the steps e) and f) being implemented by means of an electronic processor (PR).

4. The method as claimed in claim 3, wherein said step e) comprises a location of said individual fluorescent emitters by estimating the centers of diffraction spots (TD) present in the images acquired in the step b).

5. The method as claimed in claim 3, also comprising a step g) of space-time correlation between the images acquired in the step b) and the arrival delays of the fluorescence photons measured in the step d) to associate said fluorescence lifetimes with said individual fluorescent emitters.

6. The method as claimed in claim 2, wherein said matrix of photon-counting detectors comprises a plurality of said detectors (DCP) arranged according to a plurality of rows and of columns.

7. The method as claimed in claim 1, wherein the fluorescent emitters contained in the sample are convertible and the step a) comprises the illumination of the sample by means of said excitation light beam (FL2) and a conversion light beam (FL1), the conversion light beam having a wavelength that is different from that of the excitation light beam and is chosen so as to activate said fluorescent emitters by provoking their conversion from a first state to a second state that is different from the first, the intensity of the conversion light beam being chosen such that, during the time of acquisition of one said image, at most one individual fluorescent emitter (EFI) is activated on average in a region of the sample corresponding to one said set of pixels of the matrix image sensor.

8. The method as claimed in claim 1, wherein the sample:
has a sub-micrometric thickness,
is deposited on a face (SS) of a dielectric support (SDT) that is transparent to the wavelength of the excitation light beam,
has a surface opposite the support which is functionalized with molecules of a first type (BR1) and is placed in contact with a solution containing molecules of a second type (BR2) bonded to fluorescent emitters (EF) and susceptible to bonding transiently with the molecules of the first type by a reaction having a kinetic such that, on average, at most one molecule of the second type is bonded to a molecule of the first type in a region of the sample corresponding to one said set of pixels of the matrix image sensor;
the step a) comprising the illumination of the sample by total internal reflection by means of said excitation light beam such that the fluorescent emission from the sole fluorescent emitters situated at a sub-micrometric distance from the face of the dielectric support is activated.

9. A super-resolution fluorescence microscopy device comprising:
a means for stochastic activation of fluorescent emitters contained in a sample (E) to be observed;
a light source (SL2), called excitation light source, suitable for emitting a light beam, called excitation light beam (FL2), at a wavelength suitable for inducing a fluorescent emission from the activated fluorescent emitters;
an optical system (MD1, L1, MD2, OBJ) configured to direct the excitation light beam toward the sample (E);
an optical detection system (SIM, SCP) comprising a matrix image sensor (CIM) configured to acquire a sequence of fluorescence images (IM) of said sample; wherein:
said excitation light source is a pulsed source, the time interval between two successive pulses of this source being greater than the fluorescence lifetime of the fluorescent emitters;
and in that the optical detection system is also configured to perform a counting of photons of the fluorescent emission to determine arrival delays (Δt₁, Δt₂) of said photons relative to the pulses (IL2) of said second light beam, said counting being performed with a spatial resolution allowing each photon to be associated with a set of pixels (EPX) of said matrix image sensor.

10. The device as claimed in claim 9, wherein the optical detection system comprises:
an imaging system (SIM) configured to acquire said sequence of fluorescence images of said sample;
a photon-counting detector or matrix of detectors (MDCP) arranged so as to receive a portion of a fluorescent emission from said sample, said or each detector (DCP) of the matrix being associated with said set of pixels (EPX) of said matrix image sensor; and
an electronic circuit (CMR) associated with said photon-counting detector or matrix of detectors, configured to measure arrival delays of photons arriving on said or each said detector relative to the pulses of said excitation light beam.

11. The device as claimed in claim 10, also comprising an electronic processor (PR) configured to:
receive as input the sequence of fluorescence images acquired by said matrix image sensor and use it to construct a super-resolution image by locating, in the images of the sequence, individual fluorescent emitters;
receive as input delay measurements obtained by said electronic circuit and use them to calculate fluorescence lifetimes; and
associate said fluorescence lifetimes with the located individual fluorescent emitters.

12. The device as claimed in claim 11, wherein said electronic processor is configured to locate said individual fluorescent emitters by estimating the centers of diffraction spots (TD) present in the images acquired by said matrix image sensor.

13. The device as claimed in claim 11, wherein said electronic processor is configured to associate said fluorescence lifetimes with the located individual fluorescent emitters by performing a space-time correlation between the images acquired by said matrix image sensor and the delay measurements obtained by said electronic circuit.

14. The device as claimed in claim 11, wherein said photon-counting detector or detectors are individual photon avalanche diodes.

15. The device as claimed in claim 11, comprising one said matrix of photon-counting detectors.

16. The device as claimed in claim 15, wherein said matrix of photon-counting detectors is a matrix of non-contiguous individual photon avalanche diodes, the device also comprising a matrix of contiguous convergent microlenses (MML) comprising one said microlens arranged facing each individual photon avalanche diode of the matrix, each said microlens being optically conjugate with a set of pixels of said matrix image sensor.

17. The device as claimed in claim 11, comprising a plurality of said photon-counting detectors (DCP), the device also comprising a bundle of optical fibers (FF) arranged in such a way that a first end face of each optical fiber is optically conjugate with a set of pixels of said matrix image sensor, one said photon-counting detector being arranged facing a second end face of each said optical fiber.

18. The device as claimed in claim 11, wherein the means for stochastic activation of fluorescent emitters comprises a light source (SL1), called conversion light source, suitable for emitting, toward the sample, a light beam (FL1), called conversion light beam, having a wavelength different from that of the excitation light beam and chosen so as to activate said fluorescent emitters, which are of photoconvertible type, by provoking their conversion from a first state to a second state that is different from the first, the intensity of the conversion light beam being chosen such that, during the time of acquisition of one said image, at most one individual fluorescent emitter (EFI) is activated on average in a region of the sample corresponding to one said set of pixels of the matrix image sensor.

19. The device as claimed in claim 11, wherein the means for stochastic activation of fluorescent emitters comprises a dielectric support (SDT) that is transparent to the wavelength of the excitation light beam, on a face (SS) of which the sample can be deposited, and a fluid tank (CF) containing said support;
said optical system being configured to direct the excitation light beam through the support such that it undergoes a total internal reflection on said face.

20. A computer program product comprising computer-executable instructions for, when said program is run on a computer:
receiving as input a sequence of images (IM) of fluorescent emission from a sample (E) containing individual fluorescent emitters, acquired by means of an imaging system (SIM) comprising a matrix image sensor (CIM);
receiving as input arrival delays (Δt₁, Δt₂) of photons of said fluorescent emission relative to pulses of a pulsed light beam, said photons being detected by a photon-counting detector or matrix of detectors (MDCP), said or each detector of the matrix (DCP) being associated with a set of pixels (EPX) of said matrix image sensor;
using said sequence of images to construct a super-resolution image of the sample by locating said individual fluorescent emitters; and
using the arrival delays of the photons of said fluorescent emission to calculate fluorescence lifetimes and associate them with said individual fluorescent emitters.
